(19) United States
(12) Patent Application Publication
(10) Pub. No.: US 2025/0091560 A1
(43) Pub. Date: Mar. 20, 2025

(54) HYDRAULIC BOOST FAILURE COMPENSATION SYSTEM

(71) Applicant: Robert Bosch GmbH, Stuttgart (DE)

(72) Inventor: David Safstrom, Toledo, OH (US)

(21) Appl. No.: 18/887,939

(22) Filed: Sep. 17, 2024

Related U.S. Application Data
(60) Provisional application No. 63/583,790, filed on Sep. 19, 2023.

(51) Int. Cl. B60T 13/66; B60T 7/04; B60T 13/74

(52) U.S. Cl. CPC B60T 13/662; B60T 7/042; B60T 13/745; B60T 2220/04

(57) ABSTRACT

An automotive vehicle braking system comprising an electronic control unit (ECU) for the vehicle electrically connected to a vehicle controller area network (CAN) bus, an electro-hydraulic power steering (EHPS) system electrically connected to the ECU via the vehicle CAN bus, the EHPS system configured to generate a signal including the state of the EHPS system, an electrically driven power steering pump connected to the EHPS system, and an electronic stability controller configured to receive the signal from the EHPS system, evaluate the signal to determine if the EHPS system is in a fault state, receive supplemental signals, evaluate the supplemental signals for supplemental pressure requests, arbitrate the supplemental pressure requests and the EHPS system fault state to determine a pressure actuation, and in response to the determination of the pressure actuation, control the electrically driven power steering pump to increase hydraulic pressure within the EHPS system.

### RELATED APPLICATIONS

This application claims the benefit of U.S. Provisional Patent Application No. 63/583,790, filed Sep. 19, 2023, the entire content of which is hereby incorporated by reference.

### FIELD

Embodiments, examples, and aspects described herein relate to, among other things, a system and method for controlling a hydraulic braking system of a vehicle.

### SUMMARY

Many vehicles, such as large trucks, include a brake booster which is powered by high pressure hydraulic fluid. The high-pressure hydraulic fluid is commonly supplied by a power steering pump. When the hydraulic power steering system experiences a failure, such as reduced pressure, the hydraulic brake booster has reduced capacity to generate brake fluid pressure and decelerate the vehicle according to the operator's braking intention. Therefore, systems and methods configured to detect hydraulic booster failure and compensate by generating additional brake pressure downstream of the brake modulator advantageously allow for improved operator experience.

In some aspects, the techniques described herein relate to an automotive vehicle braking system. In one example, the system includes an electronic control unit (ECU) for the vehicle electrically connected to a vehicle controller area network (CAN) bus, and an electro-hydraulic power steering (EHPS) system electrically connected to the ECU via the vehicle CAN bus. The EHPS system is configured to generate a signal including a state of the EHPS system. The systems also includes an electrically driven power steering pump connected to the EHPS system and an electronic stability controller electrically connected to the vehicle CAN bus. The electronic stability controller includes an electronic processor. The electronic processor is configured to receive the signal from the EHPS system, evaluate the signal to determine if the EHPS system is in a fault state; receive supplemental signals; and evaluate the supplemental signals for supplemental pressure requests. The electronic processor arbitrates the supplemental pressure requests and the EHPS system fault state to determine a pressure actuation. In response to determining a pressure actuation, the electronic processor controls the electrically driven power steering pump to increase hydraulic pressure within the EHPS system.

In some aspects, the techniques described herein relate to a system, wherein the state of the EHPS system is a hydraulic pressure within the EHPS system being below a threshold. In some aspects, the techniques described herein relate to a system, wherein the supplemental signals include a motor torque signal or a brake pedal stroke signal. In some aspects, the techniques described herein relate to a system, wherein the supplemental pressure requests are one selected from a group consisting of a hydraulic brake boost, an active engine braking, an adaptive cruise control, and a hill hold control. In some aspects, the techniques described herein relate to a system, wherein the electronic processor is further configured to determine a priority for the supplemental pressure requests before arbitrating the supplemental pressure requests and the EHPS system fault state to determine a pressure actuation.

In some aspects, the techniques described herein relate to a system, wherein the electronic processor is further configured to: evaluate the supplemental signals for supplemental pressure requests via a first coordinator; evaluate core functions via a vehicle stability program stored in a memory of the electronic stability controller; determine a priority for the supplemental pressure requests and the core functions via a second coordinator; and in response to the priority, control the electrically driven power steering pump within the EHPS system.

In some aspects, the techniques described herein relate to a system, wherein the electronic processor is further configured to: receive a measurement of a braking pressure applied to a brake pedal; determine that the EHPS system is in a degraded state; and in response to the degraded state, control the electrically driven power steering pump to increase hydraulic pressure within the EHPS system by an amount that is proportional to the measurement of a braking pressure applied to a brake pedal.

In some aspects, the techniques described herein relate to a system, wherein the degraded state includes a hydraulic pressure level within a high-pressure hydraulic line that is reduced below 100%. In some aspects, the techniques described herein relate to a system, wherein the electronic processor is further configured to: receive a measurement of a motor torque signal, and evaluate the supplemental signals and the motor torque signal for supplemental pressure requests.

In some aspects, the techniques described herein relate to an automotive vehicle braking system. The system includes an electronic control unit (ECU) for the vehicle. The ECU is electrically connected to a vehicle controller area network (CAN) bus. The system also includes an electro-hydraulic power steering (EHPS) system electrically connected to the ECU via the vehicle CAN bus. The EHPS system is configured to generate a signal including a state of the EHPS system. An electrically driven power steering pump is connected to the EHPS system. The electrically driven power steering pump includes a hydraulic pressure. A pedal stroke sensor configured is to measure a braking pressure applied to a brake pedal of the vehicle. An electronic stability controller is electrically connected to the vehicle CAN bus The electronic stability controller includes an electronic processor. The electronic processor is configured to receive the signal from the EHPS system, receive a measurement of a braking pressure applied to the brake pedal, evaluate the signal to determine if the EHPS system is in a fault state, and in response to determining that the EHPS system is in fault state, control the electrically driven power steering pump to increase the hydraulic pressure within the EHPS system an amount proportional to the measurement of the braking pressure.

In some aspects, the techniques described herein relate to a system, wherein the state of the EHPS system is a hydraulic pressure within the EHPS system being below a threshold. In some aspects, the techniques described herein relate to a system, wherein the fault state is a degraded state that includes a hydraulic pressure level within a high-pressure hydraulic line that is reduced below 100%. In some aspects, the techniques described herein relate to a system, wherein the electronic processor is further configured to receive a measurement of a motor torque signal; and evaluate supplemental signals and the motor torque signal for supplemental pressure requests.

In some aspects, the techniques described herein relate to a system, wherein the controller further receives a supplemental signal and arbitrates a supplemental pressure requests based upon the supplemental signal, wherein the supplemental pressure request is one selected from a group consisting of a hydraulic brake boost, an active engine braking, an adaptive cruise control, and a hill hold control.

In some aspects, the techniques described herein relate to a method of controlling an automotive vehicle braking system, the method including receiving an electro-hydraulic power steering (EHPS) state signal including the state of the EHPS system, receiving a hydraulic boost failure compensation pressure request, receiving at least one supplemental pressure request; arbitrating the supplemental pressure requests and a EHPS system fault state to determine a pressure request; and generating a pressure actuation in response to the pressure request.

In some aspects, the techniques described herein relate to a method, wherein the supplemental pressure requests are one selected from a group consisting of a hydraulic brake boost, an active engine braking, an adaptive cruise control, and a hill hold control. In some aspects, the techniques described herein relate to a method, the method further including determining a priority for the supplemental pressure requests before arbitrating the supplemental pressure requests and the EHPS system fault state to determine a pressure actuation.

In some aspects, the techniques described herein relate to a method, the method further including: evaluating the supplemental signals for supplemental pressure requests via a first coordinator; evaluating core functions via a vehicle stability program; determining a priority for the supplemental pressure requests and the core functions via a second coordinator; and in response to the priority, controlling an electrically driven power steering pump within the EHPS system.

In some aspects, the techniques described herein relate to a method, the method further including: determining that the EHPS system is in a degraded state that includes a hydraulic pressure level within a high-pressure hydraulic line that is reduced below 100%; and in response to the degraded state, controlling an electrically driven power steering pump to increase hydraulic pressure within the EHPS system. In some aspects, the techniques described herein relate to a method, the method further comprising determining a pressure actuation based upon an actuation of a brake pedal via the supplemental pressure requests and a EHPS system fault state.

### BRIEF DESCRIPTION OF THE DRAWINGS

FIG. 1 is a schematic illustration of a vehicle including a controller, according to some aspects.

FIG. 2A is a schematic illustration of a vehicle hydraulic system, according to some aspects.

FIG. 2B is a graph illustrating a comparison of hydraulic braking experiences, according to some aspects.

FIG. 3 is schematic illustrating a structure of control of a vehicle hydraulic power steering system, according to some aspects.

FIG. 4 is a schematic illustrating a structure of control of a vehicle electro-hydraulic power steering system, according to some aspects.

FIG. 5 is a schematic illustrating a structure of control of a vehicle electro-hydraulic power steering system, according to some aspects.

FIG. 6 is a schematic illustrating a structure of control of an internal combustion engine driven vehicle hydraulic power steering system, according to some aspects.

FIG. 7 is a schematic illustrating a structure of control of an internal combustion engine driven vehicle hydraulic power steering system, according to some aspects.

FIG. 8 is a schematic illustrating a structure of control of a vehicle electro-hydraulic power steering system, according to some aspects.

FIG. 9 is a flowchart illustrating a method of controlling vehicle electro-hydraulic power steering system, according to some aspects.

### DETAILED DESCRIPTION

Before any aspects, features, or instances are explained in detail, it is to be understood that the aspects, features, or instances are not limited in their application to the details of construction and the arrangement of components set forth in the following description or illustrated in the following drawings. Other instances are possible and are capable of being practiced or of being carried out in various ways.

Also, it is to be understood that the phraseology and terminology used herein is for the purpose of description and should not be regarded as limiting. The terms “mounted,” “connected” and “coupled” are used broadly and encompass both direct and indirect mounting, connecting, and coupling. Further, “connected” and “coupled” are not restricted to physical or mechanical connections or couplings, and can include electrical connections or couplings, whether direct or indirect. Also, electronic communications and notifications may be performed using any known means including wired connections, wireless connections, etc

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

It should also be understood that a plurality of hardware and software based devices, as well as a plurality of different structural components may be utilized in various implementations. Aspects, features, and instances may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one instance, the electronic based aspects of the invention may be implemented in software (for example, stored on non-transitory computer-readable medium) executable by one or more processors. In addition, although certain drawings illustrate hardware and software located within particular devices, these depictions are for illustrative purposes only. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations. To reiterate, those electronic processors and processing may be distributed.

For ease of description, some or all of the example systems presented herein are illustrated with a single exemplar of each of its component parts. Some examples may not describe or illustrate all components of the systems. Other instances may include more or fewer of each of the illustrated components, may combine some components, or may include additional or alternative components.

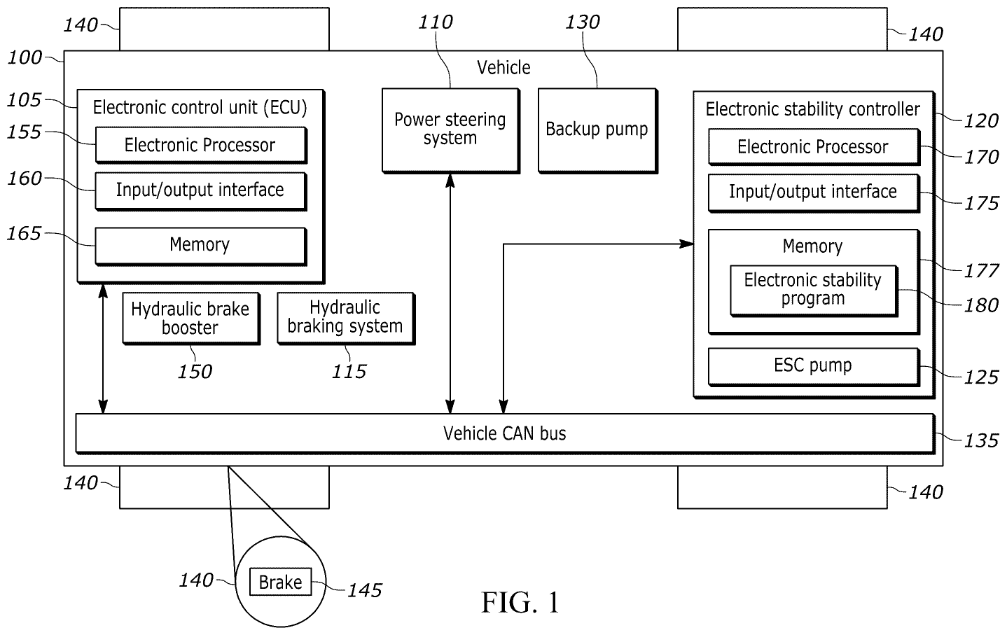

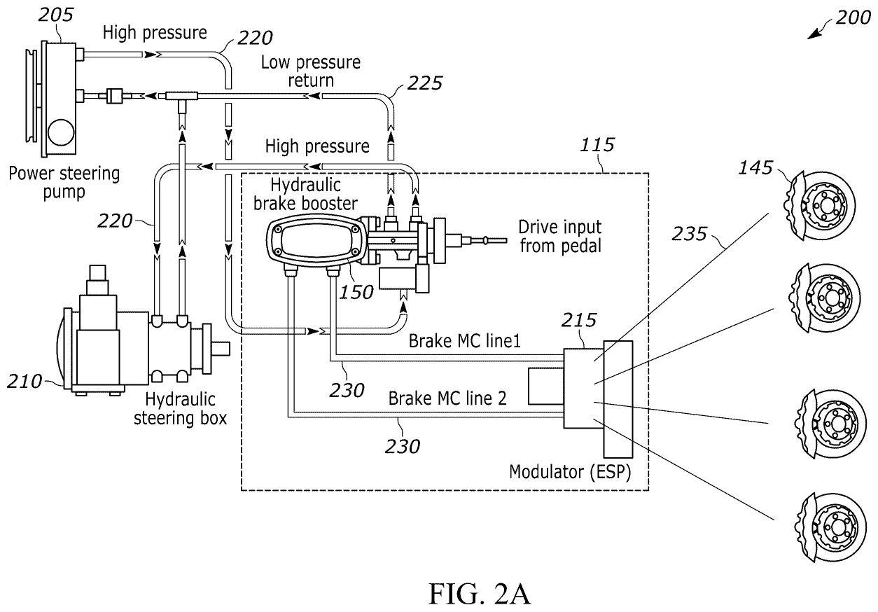

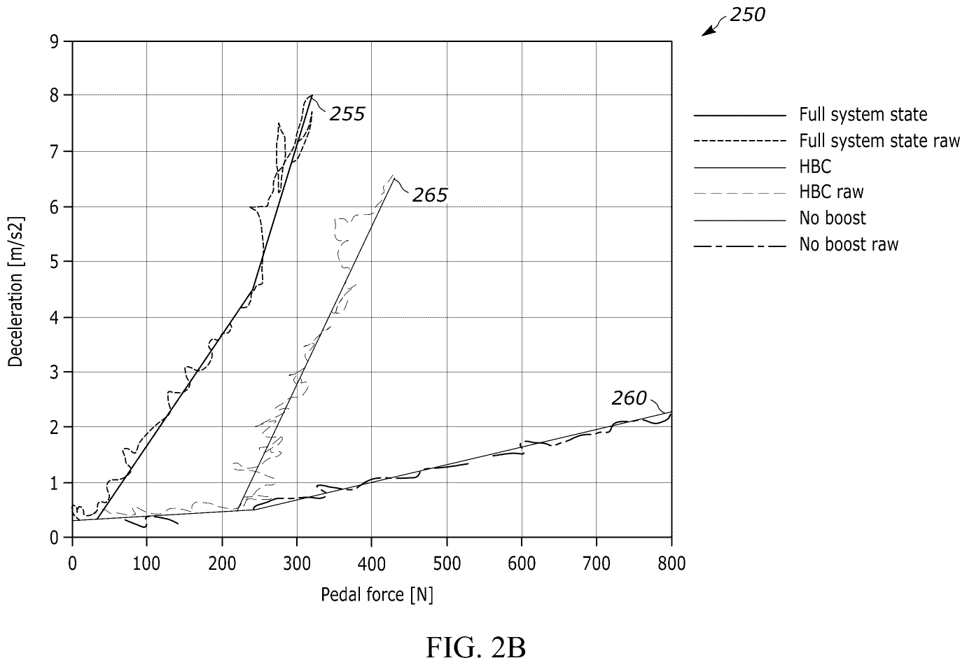

FIG. 1 schematically illustrates a vehicle 100, according to some aspects. In some instances, the vehicle 100 is a truck. In the illustrated example, the vehicle 100 includes an electronic control unit (ECU) 105, a power steering system 110, a hydraulic braking system 115, an electronic stability controller (ESC) 120, and an ESC pump 125. Some vehicles may also include power steering pump 205 (see FIG. 2A) and/or a backup pump 130. The components of the vehicle 100, along with other various modules and components are electrically and communicatively coupled to each other via direct connections, or via, or through, one or more control or data buses (for example, bus 135), which enable communication therebetween. In some instances, the bus 135 is a controller area network (CAN) bus. In some instances, the bus 135 is an automotive Ethernet, a FlexRay™ communications bus, or another suitable bus. In alternative instances, some or all of the components of the vehicle 100 may be communicatively coupled using suitable wireless modalities (for example, Bluetooth™ or near field communication connections).

The ECU 105 includes an electronic processor 155, an input/output interface 160, and a memory 165. In some examples, the electronic processor 155 is implemented as a microprocessor with separate memory, for example the memory 165. In other examples, the electronic processor 155 may be implemented as a microcontroller (with memory 165 on the same chip). In other examples, the electronic processor 155 may be implemented using multiple processors. In addition, the electronic processor 155 may be implemented partially or entirely as, for example, a field-programmable gate array (FPGA), an applications specific integrated circuit (ASIC), and the like and the memory 165 may not be needed or be modified accordingly. In some examples, the memory 165 includes non-transitory, computer-readable memory that stores instructions that are received and executed by the electronic processor 155 to carry out methods described herein. The memory 165 may include, for example, a program storage area and a data storage area. The program storage area and the data storage area may include combinations of different types of memory, for example read-only memory and random-access memory. The input/output interface 160 may include one or more input mechanisms and one or more output mechanisms (for example, general-purpose input/outputs (GPIOs), analog inputs, digital inputs, and others).

The ESC 120 includes an electronic processor 170, an input/output interface 775, and a memory 177. The electronic processor 170, the input/output interface 775, and the memory 177 may be similarly configured as the electronic processor 170, the input/output interface 775, and the memory 177 as previously described. In some instances, elements of the ESC 120 are combined with elements of the ECU 105. For instance, in some examples, the electronic processor 170 may perform the same or similar processes as the electronic processor 155. In other examples, the same processor may perform both processes. The memory 177 of the ESC 120 includes stored instructions for executing programs, such as a vehicle stability program (referred to as VSP 180). The VSP 180 contains a set of instructions for controlling the pressure within the various hydraulic components of the vehicle 100, such as the power steering system 110 and/or the hydraulic braking system 115. The structure and functioning of the VSP 180 is detailed further in the systems and methods described herein, as well as the associated figures.

The hydraulic braking system 115 of the vehicle 100 is hydraulically coupled to at least one wheel 140 that includes a brake 145, for example, a brake having hydraulically actuated brake calipers or brake drums. In many common hydraulic braking systems, when the operator of the vehicle 100 presses down on a brake pedal, it pushes a piston inside a master cylinder, which pressurizes the brake fluid. The pressurized brake fluid is then sent through the brake lines to the brake 145, which slows rotation of the wheel 140 via friction (on the brake disc or drum) to slow down or bring the vehicle 100 to a stop. A hydraulic brake booster (HBB), also referred to as a brake booster 150, is a device that helps to amplify the force applied by the operator on the brake pedal. In some instances, a brake booster uses vacuum pressure from the vehicle engine to increase or amplify hydraulic pressure. In other instances, a brake booster 150 uses an electric pump with an electric motor to increase hydraulic pressure and assist the operator in applying the brake 145. In instances where the brake booster 150 includes an electric motor, the VSP 180 may be configured to receive a signal from the brake booster 150 via the bus 135. The signal may include data about the state of the brake booster 150 and/or the state of the electric motor.

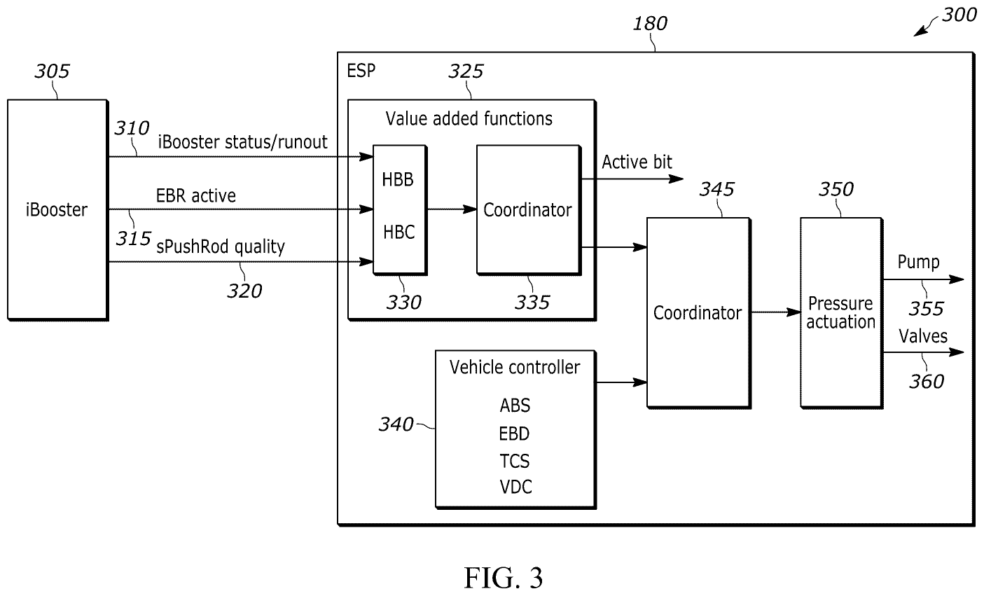

FIG. 2A is a schematic illustration of a vehicle hydraulic system, according to some aspects and examples. The hydraulic system 200 includes elements described with respect to FIG. 1 regarding the vehicle 100. For example, the power steering system 110 of the vehicle 100 includes a power steering pump 205, a hydraulic steering box 210, an ESC modulator 215, one or more high pressure hydraulic lines 220, and one or more low-pressure hydraulic returns 225. The hydraulic system 200 also includes brake lines 230 and the previously described brake booster 150. In some situations (for example, a pump failure), pressure in a high-pressure hydraulic line 220 from the power steering system 110 is reduced. This condition can cause the hydraulic booster to fail to produce a desired amount of pressure within the hydraulic braking system 115 downstream from the power steering system 110. Low hydraulic pressure levels within the high-pressure hydraulic line 220 may be due to a fault in a pump connected to the power steering system 110, such as ESC pump 125 or backup pump 130. Other fault conditions, such as low fluid levels, may also lead to reduced hydraulic pressure within the high-pressure hydraulic line 220. It is therefore advantageous to include a hydraulic boost failure compensation (HBC) system to account for these failures and provide increased hydraulic pressure downstream from the ESC modulator 215. For example, if a low-pressure condition is detected within the high-pressure hydraulic line 220, the ESC 120 may control the ESC pump 125 to draw additional fluid from a reservoir through the brake lines 230 in order to provide the required downstream high pressure to the wheel end hydraulic lines 235. Additional examples and aspects for detecting low pressure within the high-pressure hydraulic line 220 and compensating for hydraulic booster failure are detailed in FIGS. 3-9 and below.

FIG. 2B is a graph 250 illustrating a comparison of hydraulic braking experiences, according to some aspects. The graph 250 includes an X-axis illustrating a pedal force measured in Newtons of a force applied by the vehicle 100 operator to the vehicle 100 brake pedal. The graph 250 includes a Y-axis including a deceleration of the vehicle 100 measured in meters per second squared. The graph 250 includes a first deceleration curve 255 illustrating a deceleration of the vehicle 100 at a full system state. In the full system state, the vehicle 100 operator is able to decelerate the vehicle using the brake booster 150. In other words, the first deceleration curve 255 illustrates the system without any hydraulic brake booster faults. The graph 250 also includes a second deceleration curve 260 illustrating a deceleration of the vehicle 100 without the benefit of a brake booster. In other words, the second deceleration curve 260 illustrates the system with at least one hydraulic brake booster fault. Notably, the second deceleration curve 260 requires more pedal force to decelerate and achieves a lower deceleration than the first deceleration curve 255. The graph 250 also includes a third deceleration curve 265 illustrating a deceleration of the vehicle 100 utilizing the HBC to compensate for a failed brake booster. In other words, the third deceleration curve 265 illustrates the system with at least one hydraulic brake booster fault for which the HBC system is compensating. As demonstrated in the graph 250, the third deceleration curve 265 illustrates the vehicle 100 decelerating at a much faster rate than the second deceleration curve 260. This exhibits the greater amount of potential deceleration available to the operator of the vehicle 100 when utilizing the HBC system as opposed to no HBC system at all. It should be understood that the first, second, and third decelerations (255, 260, 265) are only some of the possible vehicle decelerations, and in other instances different decelerations are possible.

FIG. 3 is a schematic illustrating a structure of control of a vehicle hydraulic system 300, according to some aspects. The system 300 includes a brake booster 305 and the VSP 180. In some instances, the brake booster 305 includes a belt driven hydraulic pump. The brake booster 305 is configured to generate signals and communicate with the VSP 180. The signals include a status signal 310, an EBR active signal 315, and a pushrod signal 320. The status signal 310, the EBR active signal 315, and the pushrod signal 320 are sent to the ESC 120 and used as variable inputs (also referred to as variables 330) to one or more value added functions 325 of the VSP 180. The value-added function 325 may include a hydraulic brake boost (HBB) function, an active engine braking (AEB) function, an adaptive cruise control (ACC) function, a hill hold control (HHC) function, or the like. The variables 330 (which are based on the signals (310, 315, 320) from the brake booster 305) are then arbitrated by a first coordinator 335. The first coordinator 335 determines which of the outputs (and as a necessary corollary which of the value-added function 325) is a priority for a pressure request. For instance, the first coordinator 335 may determine that the HBC may take priority over the ACC. In this case, the first coordinator 335 prioritizes the HBC, and outputs the HBC pressure request. In some examples, the first coordinator 335 determines the priority of the pressure requests before any arbitration occurs. The VSP 180 also receives information from core functions 340 (which reside in the ECU 105) via various vehicle sensors configured to transmit signals containing the data of the core functions 340. In some examples, the core functions 340 are received by the VSP 180 via a core function signal. The core functions 340 are critical vehicle functions that may take priority over other vehicle functions. The core functions 340 may include an antilock braking system (ABS) function, an electronic brakeforce distribution (EBD) function, a traction control system (TCS) function, a vehicle dynamic control (VDC) function, or other functions. The ECU 105 transmits one or more signals to the ESC 120 including information regarding the core functions 340.

The system 300 includes a second coordinator 345 configured to receive information or outputs from the core functions 340 and the outputs of the first coordinator 335. The second coordinator 345 then arbitrates the outputs of the core functions 340 and the output of the first coordinator. In general, the arbitration of the first coordinator is performed in a manner that is similar to the manner in which the first coordinator 335 performs arbitration. For example, the second coordinator 345 may determine that the vehicle ABS pressure request takes priority over the HBC pressure request. In this case, the second coordinator 345 prioritizes the ABS function, and outputs the ABS pressure request. Once the second coordinator 345 has determined which pressure request to prioritize, it outputs a request to a pressure actuation 350 control, which in turn sends control signals to various actuators, for example, a pump control signal 355 and/or a valve control signal 360.

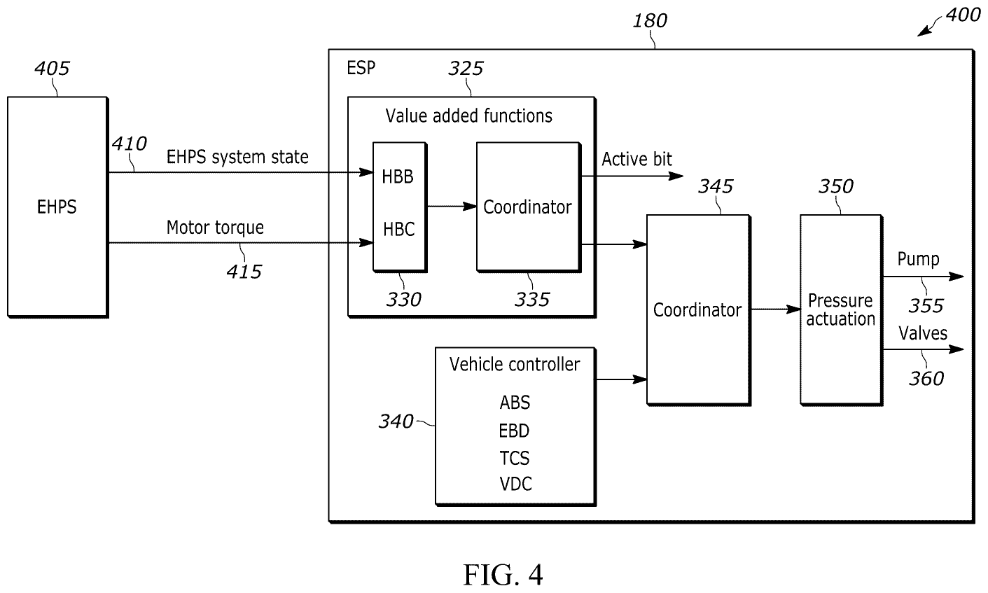

FIG. 4 is a schematic illustrating a structure of control of a vehicle hydraulic system 400, according to some aspects. The system 400 includes the VSP 180 as previously described in FIG. 3. However, in contrast to system 300, the system 400 includes an electro-hydraulic power steering (EHPS) system, referred to as EHPS system 405. The EHPS system 405 combines both hydraulic and electric power to assist the operator of the vehicle 100. In the EHPS system 405, the hydraulic pressure that assists in turning the wheel is generated by an electromechanical motor-driven hydraulic pump, such as ESC pump 125, rather than a belt-driven pump of system 300. In some instances, the EHPS system 405 is configured to be more efficient than a traditional hydraulic power steering systems, such as system 300, as it only consumes power when assistance is required. The EHPS system 405 may also offer more precise control and better feedback to the driver.

The EHPS system 405 is configured to generate a system state signal 410 that includes a plurality of system states of the EHPS system 405. The plurality of system states may include, for example, that hydraulic pressure within the EHPS system 405 is below a threshold, indicating a fault or failure. Other states may include a pump failure (such as, for example, ESC pump 125, backup pump 130, or other pumps), more than one hydraulic pressure threshold, or the like. The system state signal 410 is used by the VSP 180 as a variable 330 input to the value-added function 325. The value-added function 325 then processes the variable 330 as previously described above. Additionally, or alternatively, a motor torque signal 415 may be generated by a torque sensor, and the motor torque signal 415 used as a variable 330 input to the VSP 180. For example, if the VSP 180 receives the system state signal 410 and determines that the state of the EHPS system 405 is failed, the VSP 180 may not need to evaluate a motor torque signal 415 in order to activate the hydraulic boost failure compensation. On the other hand, if the state of the EHPS system 405 is not failed but rather degraded, such as a hydraulic pressure level within the high-pressure hydraulic line 220 that is reduced by 20% (e.g., reduced below 100%), the VSP 180 may evaluate the motor torque signal 415 as a supplemental input. In other words, the VSP 180 may use the motor torque signal 415 in addition to the one or more system states of the EHPS system 405 to control the HBC pressure request, and ultimately generate the pressure actuation 350 as described above. In some examples, the hydraulic pressure may be increased by an amount that is proportional to the measurement of braking pressure.

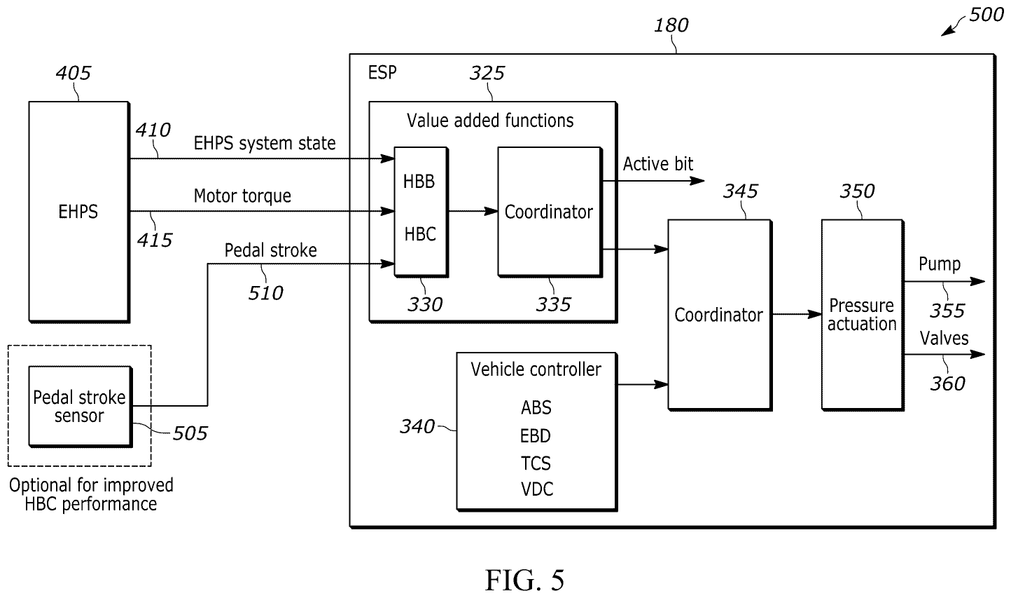

FIG. 5 is a schematic illustrating a structure of control of a vehicle hydraulic system 500, according to some aspects. Similar to FIG. 4, the system 500 includes the EHPS system 405 and the VSP 180 configured to receive the system state signal 410 as a variable 330 to the value-added function 325. However, system 500 also includes a pedal stroke sensor 505 configured to detect the position of brake pedal of the vehicle 100. The pedal stroke sensor 505 is configured to generate a pedal stroke signal 510 including information regarding the desired braking experience requested by the operator of the vehicle 100. For example, the more the operator depresses (e.g., actuates) the brake pedal, the greater the amount of deceleration is requested by the operator of the vehicle 100. The pedal stroke signal 510 is then used as a variable 330 input to the value-added function 325 of the VSP 180 and processed similarly as previously described alternative inputs. The inclusion of the pedal stroke sensor 505 in the system 500 allows the system to gauge the intent of the operator of the vehicle more accurately in circumstances where hydraulic pressure within the high-pressure hydraulic line 220 is reduced. For instance, some vehicles may not have a backup pump 130. In these vehicles, if the vehicle experiences low hydraulic pressure within the high-pressure hydraulic line 220, the brake pedal may move away from the operator. Without the inclusion of the pedal stroke sensor 505, the VSP 180 may not be able to determine the difference between this pressure reduction caused by the fault condition and the pressure reduction caused by the operator removing their foot from the brake pedal. By including the pedal stroke sensor 505 and the pedal stroke signal 510 as a variable 330 input, the VSP 180 is able to gauge the operator's desired braking experience.

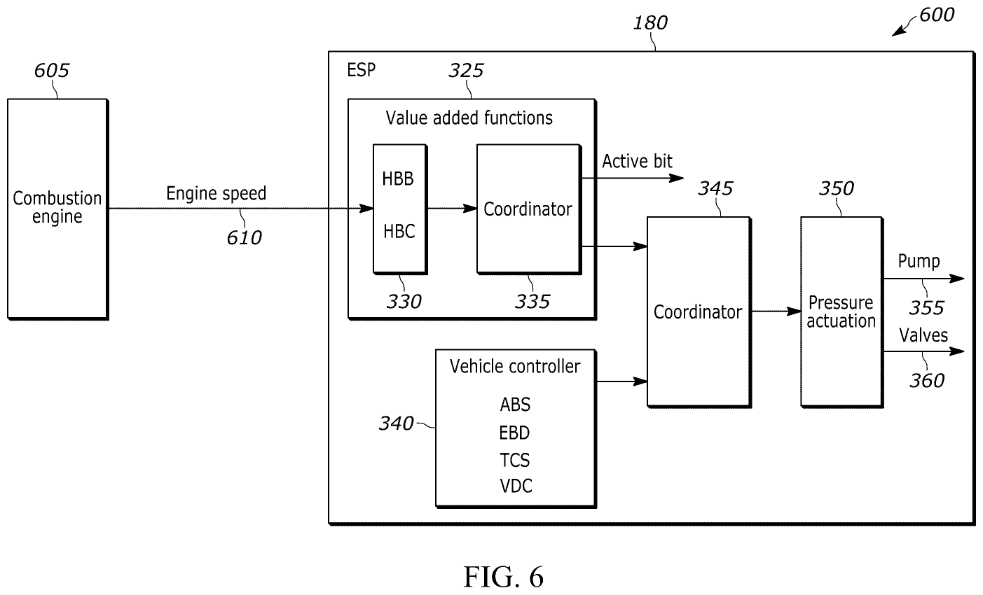

FIG. 6 is a schematic illustrating a structure of control of an internal combustion engine driven vehicle hydraulic system 600, according to some aspects. The system 600 includes VSP 180 configured to receive a variable 330 input to the value-added function 325. However, system 600 includes an internal combustion engine 605 instead of an EHPS system. An internal combustion engine 605 driven power steering system uses hydraulic pressure to assist the driver in turning the vehicle's wheel. In system 600, the power steering pump is driven by the engine through a belt or other mechanical means. One or more sensors may record the revolutions per minute (RPM), or engine speed, of the internal combustion engine 605 and generate an engine speed signal 610. This engine speed signal 610 may then be used by the VSP 180 as a variable 330 input to the value-added function 325 and processed similarly as previously described alternative inputs. For instance, if the VSP 180 receives the engine speed signal 610 indicating that the speed of the internal combustion engine 605 is below a predetermined threshold, the VSP 180 may determine that the hydraulic pressure is too low, and activate the HBC as previously described.

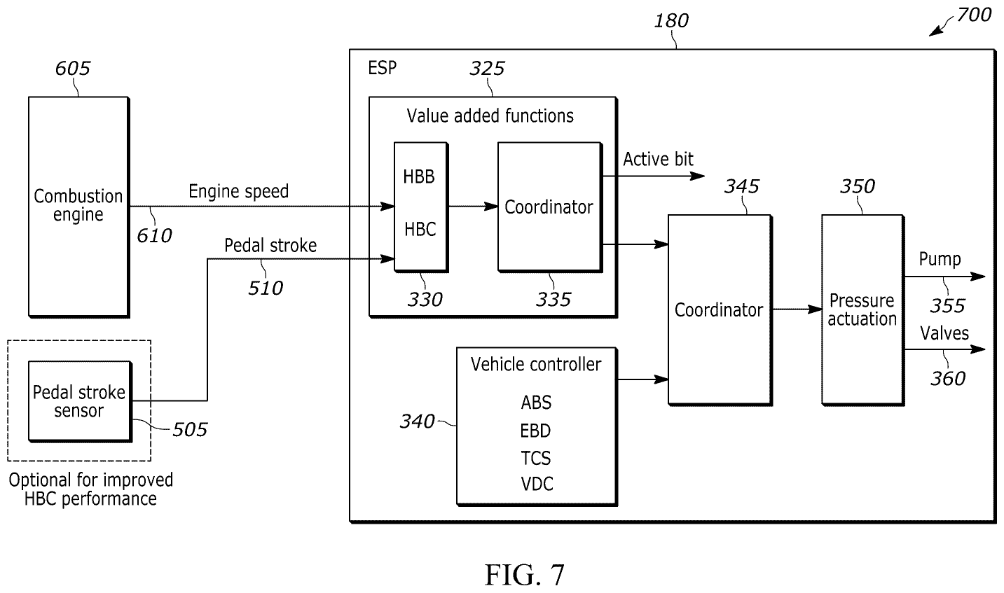

FIG. 7 is a schematic illustrating a structure of control of an internal combustion engine driven vehicle hydraulic system 700, according to some aspects. Similar to system 600, the system 700 includes the internal combustion engine 605 and the VSP 180 configured to receive the engine speed signal 610 as a variable 330 input to the value-added function 325. However, in addition, the system 700 includes the pedal stroke sensor 505 configured to generate the pedal stroke signal 510 as described in system 500. In other words, the system 700 combines the internal combustion engine 605 of system 600 with the pedal stroke sensor 505 of system 500. The VSP 180 is then configured to use both the engine speed signal 610 and the pedal stroke signal 510 as variable 330 inputs to the value-added function 325 when determining pressure requests.

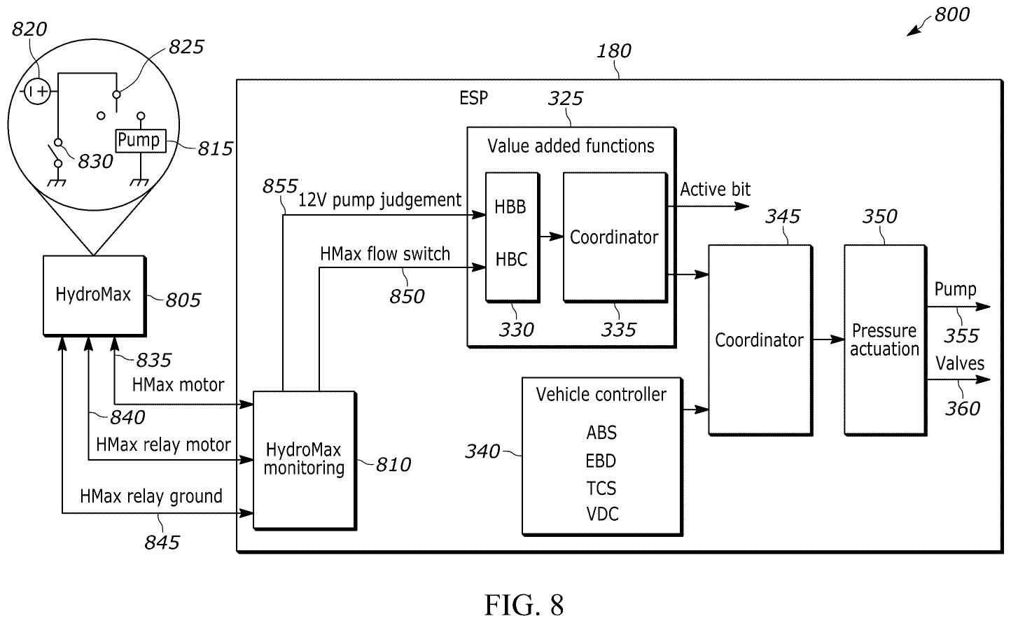

FIG. 8 is a schematic illustrating a structure of control of a vehicle electro-hydraulic system 800, according to some aspects. Similar to the previously described systems, the system 800 includes the VSP 180 configured to receive at least one variable 330 input to the value-added function 325. However, system 800 also includes a brake structure 805 with multiple electrical connections to the ESC 120, and the VSP 180 includes monitoring logic 810 configured to evaluate additional signals sent by the brake structure 805. The brake structure 805 includes a pump 815 powered by a voltage source 820 (for example, 12 Volts), a relay 825, and a flow switch 830. The ESC 120 is configured to monitor the elements of the brake structure 805 to determine conditions of the components. For example, when an operator depresses the brake pedal of the vehicle 100, the monitoring logic 810 monitors the hydraulic fluid in the high-pressure hydraulic line 220. The depression of the brake pedal turns the relay 825 ON. If there is an adequate power steering flow, the flow switch 830 is in an ON state (or open), preventing the pump 815 from being activated. However, if the flow switch 830 is in an OFF state (or closed), there is not an adequate power steering flow, and pump 815 is activated. Additionally, the monitoring logic 810 may independently evaluate the relay 825 power and the relay ground.

The monitoring logic 810 receives the monitored conditions as a pump signal 835, a relay power signal 840, and a relay ground signal 845. The monitoring logic 810 then evaluates these signals (835, 840, 845) to determine the state of the pump 815 and the state of the flow switch 830. The monitoring logic 810 then transmits this information as a variable 330 input to the value-added function 325. For instance, the monitoring logic 810 may determine that the flow switch 830 is in an OFF state and that there is not an adequate power steering flow and transmit this determination as a flow switch signal 850. Similarly, the monitoring logic 810 may determine that the pump 815 also in an OFF state and transmit this determination as a pump judgement signal 855. The flow switch signal 850 and the pump judgement signal 855 are then used as variable 330 inputs to the value-added function 325 when determining pressure requests. For example, if the value-added function 325 receives the flow switch signal 850 and the pump judgement signal 855 indicating that both the flow rate is inadequate and that the pump 815 is not operational, the VSP 180 may activate the HBC as previously described.

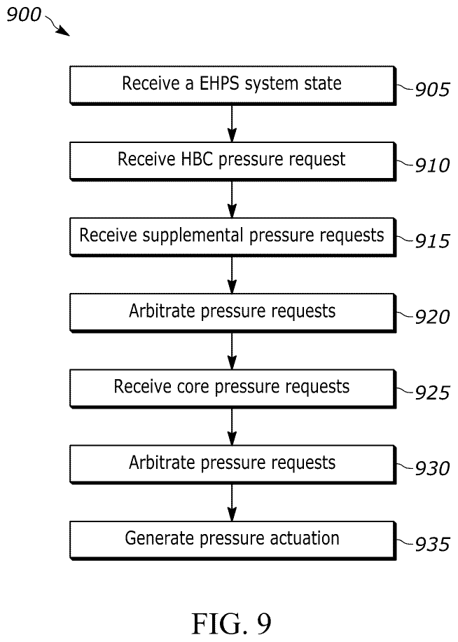

FIG. 9 is a flowchart illustrating a method 900 of controlling vehicle electro-hydraulic system, according to some aspects. The method 900 may be performed by the electronic processor 170, by the electronic processor 155, by another electronic processor, or by a different combination of electronic processors. The method 900 begins at block 905, where the EHPS system state is received. For example, the EHPS system state may be received by the VSP 180 as system state signal 410 from the EHPS system 405. The method 900 includes block 910, where the hydraulic boost failure compensation pressure request is received. The method 900 includes block 915, where supplemental pressure requests are received. These supplemental requests may include hydraulic brake boost, active engine braking, adaptive cruise control, hill hold control, or similar pressure requests as previously described.

The method 900 includes block 920, where the pressure requests are arbitrated. This arbitration may be performed, for example, by the first coordinator 335 of the VSP 180 as previously described. The arbitration is performed to determine which of the supplemental pressure requests is a priority, as previously described. For instance, the first coordinator 335 may arbitrate the supplemental pressure requests and the EHPS system fault state to determine a pressure actuation desired by the operator of the vehicle 100. Once the arbitration of the pressure requests is complete, the process generates a value-added pressure request. The process continues with block 925, where core pressure requests are received. Core pressure requests may include, for example, antilock braking systems, electronic brakeforce distribution, traction control system, vehicle dynamic control, or the like.

At block 930, the method 900 arbitrates the core pressure requests and the value-added priority pressure request. For example, the second coordinator 345 as previously described compares the value-added pressure request with any core pressure requests to determine which pressure request takes priority. Once the second coordinator 345 determines which pressure request takes priority, the process continues. At block 935, the method 900 includes generating a pressure actuation in response to the arbitration of block 930. The pressure actuation may be the pressure actuation 350 performed by the VSP 180 as previously described.

Thus, aspects herein provide, among other things, systems and methods for hydraulic boost failure compensation.

What is claimed is:

1. An automotive vehicle braking system, the system comprising:
an electronic control unit (ECU) for the vehicle electrically connected to a vehicle controller area network (CAN) bus;
an electro-hydraulic power steering (EHPS) system electrically connected to the ECU via the vehicle CAN bus, the EHPS system configured to generate a signal including a state of the EHPS system;
an electrically driven power steering pump connected to the EHPS system;
an electronic stability controller electrically connected to the vehicle CAN bus, the electronic stability controller including an electronic processor configured to:
receive the signal from the EHPS system,
evaluate the signal to determine if the EHPS system is in a fault state;
receive supplemental signals;
evaluate the supplemental signals for supplemental pressure requests;
arbitrate the supplemental pressure requests and the EHPS system fault state to determine a pressure actuation; and
in response to the determination of the pressure actuation, control the electrically driven power steering pump to increase hydraulic pressure within the EHPS system.

2. The system of claim 1, wherein the state of the EHPS system is a hydraulic pressure within the EHPS system being below a threshold.

3. The system of claim 1, wherein the supplemental signals include a motor torque signal or a brake pedal stroke signal.

4. The system of claim 1, wherein the supplemental pressure requests are one selected from a group consisting of a hydraulic brake boost, an active engine braking, an adaptive cruise control, and a hill hold control.

5. The system of claim 1, wherein the electronic processor is further configured to determine a priority for the supplemental pressure requests before arbitrating the supplemental pressure requests and the EHPS system fault state to determine a pressure actuation.

6. The system of claim 1, wherein the electronic processor is further configured to:
evaluate the supplemental signals for supplemental pressure requests via a first coordinator;
evaluate core functions via a vehicle stability program stored in a memory of the electronic stability controller;
determine a priority for the supplemental pressure requests and the core functions via a second coordinator; and
in response to the priority, control the electrically driven power steering pump.

7. The system of claim 1, wherein the electronic processor is further configured to:
receive a measurement of a braking pressure applied to a brake pedal;
determine that the EHPS system is in a degraded state; and
in response to the degraded state, control the electrically driven power steering pump to increase hydraulic pressure within the EHPS system by an amount that is proportional to the measurement of a braking pressure applied to a brake pedal.

8. The system of claim 7, wherein the degraded state includes a hydraulic pressure level within a high-pressure hydraulic line that is reduced below 100%.

9. The system of claim 7, wherein the electronic processor is further configured to:
receive a measurement of a motor torque signal; and
evaluate the supplemental signals and the motor torque signal for supplemental pressure requests.

10. An automotive vehicle braking system, the system comprising:
an electronic control unit (ECU) for the vehicle electrically connected to a vehicle controller area network (CAN) bus;
an electro-hydraulic power steering (EHPS) system electrically connected to the ECU via the vehicle CAN bus, the EHPS system configured to generate a signal including a state of the EHPS system;
an electrically driven power steering pump connected to the EHPS system, the electrically driven power steering pump including hydraulic pressure;
a pedal stroke sensor configured to measure a braking pressure applied to a brake pedal of the vehicle;
an electronic stability controller electrically connected to the vehicle CAN bus, the electronic stability controller including an electronic processor configured to:
receive the signal from the EHPS system,
receive a measurement of a braking pressure applied to the brake pedal;
evaluate the signal to determine if the EHPS system is in a fault state; and
in response to the determination that the EHPS system is in fault state, control the electrically driven power steering pump to increase the hydraulic pressure within the EHPS system an amount proportional to the measurement of the braking pressure.

11. The system of claim 10, wherein the state of the EHPS system is a hydraulic pressure within the EHPS system being below a threshold.

12. The system of claim 10, wherein the fault state is a degraded state that includes a hydraulic pressure level within a high-pressure hydraulic line that is reduced below 100%.

13. The system of claim 10, wherein the electronic processor is further configured to:
receive a measurement of a motor torque signal; and
evaluate supplemental signals and the motor torque signal for supplemental pressure requests.

14. The system of claim 13, wherein the controller further receives a supplemental signal and arbitrates a supplemental pressure request based upon the supplemental signal, wherein the supplemental pressure request is one selected from a group consisting of a hydraulic brake boost, an active engine braking, an adaptive cruise control, and a hill hold control.

15. A method of controlling an automotive vehicle braking system, the method comprising:
receiving an electro-hydraulic power steering (EHPS) state signal including the state of the EHPS system;
receiving a hydraulic boost failure compensation pressure request;
receiving at least one supplemental pressure request;
arbitrating the supplemental pressure requests and a EHPS system fault state to determine a pressure request; and
generating a pressure actuation in response to the pressure request.

16. The method of claim 15, wherein the supplemental pressure requests are one selected from a group consisting of a hydraulic brake boost, an active engine braking, an adaptive cruise control, and a hill hold control.

17. The method of claim 15, the method further comprising:
determining a priority for the supplemental pressure requests before arbitrating the supplemental pressure requests and the EHPS system fault state to determine a pressure actuation.

18. The method of claim 15, the method further comprising:
evaluating the supplemental signals for supplemental pressure requests via a first coordinator;
evaluating core functions via a vehicle stability program;
determining a priority for the supplemental pressure requests and the core functions via a second coordinator; and
in response to the priority, controlling an electrically driven power steering pump within the EHPS system.

19. The method of claim 15, the method further comprising:
determining that the EHPS system is in a degraded state that includes a hydraulic pressure level within a high-pressure hydraulic line that is reduced below 100%; and
in response to the degraded state, controlling an electrically driven power steering pump to increase hydraulic pressure within the EHPS system.

20. The method of claim 15, the method further comprising determining a pressure actuation based upon an actuation of a brake pedal via the supplemental pressure requests and a EHPS system fault state.
